(19) United States
(12) Patent Application Publication
(10) Pub. No.: US 2005/0160106 A1
(43) Pub. Date: Jul. 21, 2005

(54) Data column management system and method

(75) Inventor: Stanley Tsai, Hsin Tien City (TW)

Correspondence Address: BRUCE H. TROXELL, SUITE 1404, 5205 LEESBURG PIKE, FALLS CHURCH, VA, 22041, US

(73) Assignee: Via Technologies, Inc.

(21) Appl. No.: 11/023,578

(22) Filed: Dec. 29, 2004

Related U.S. Application Data
(60) Provisional application No. 60/533,218, filed on Dec. 31, 2003.

(51) Int. Cl. G06F 7/00

(52) U.S. Cl. 707/100

(57) ABSTRACT

A data column management system could be used for receiving an adding data column request to add a data column to an electronic document, and for receiving deleting data column request to delete a data column of the electronic document. The data column management system comprises a column data accessing module, an adding module, and a deleting module. The column data accessing module is used for accessing the serial number of a last data column of the electronic document to get a last serial number, and for accessing the format of the data column to get a format data. The adding module is used for adding an adding data column into the electronic document according to the adding data column request, the format data, and the last serial number. The format of the adding data column is the same with the data column. The serial number of the adding data column is the last serial plus one. The deleting module is used for deleting any one of the data columns of the electronic document according to the deleting request. The serial numbers of the data columns after the deleted data column are subtracted one.

### FIELD OF THE INVENTION

The present invention relates to a data column management system and particularly to a data column management system and method for adding data columns on existing data columns and entering selected data in the correct data columns.

### BACKGROUND OF THE INVENTION

The conventional electronic data column management system and method such as the one shown in FIG. 1 takes a conventional electronic document 10 for entering personal address as an example. It comprises a plurality of data columns. Referring to FIG. 1, the electronic document 10 contains a plurality of data columns, such as country and city 1022 and 1042, town and district 1024 and 1044, other address 1026 and 1046. Users can enter the corresponding data according to the shown format to complete data entry of the electronic document 10.

Due to rapid changes of the society, nowadays users often have more than two addresses. The conventional electronic document that contains a fixed number of addresses can no longer meet the requirement. Moreover, besides the addresses, there are many other personal data such as e-mail, phone number and the like. Hence the conventional design of fixed data column of the electronic document cannot meet the modern requirements.

In addition, in the conventional electronic document, there are selective popped up menus to allow users to select data and enter in the preset sub-data columns. As shown in FIG. 1, during selecting the county and city, pick a pull down table on one side, a menu will be popped up to allow the user to select the country or city required. After the user has made the selection, the selected data will be filled in the sub-data column. However, in the current applications the sub-data columns often are interrelated. For instance, if a data column is for selecting the cooperative company, then the first sub-data column is to select the company name, the second column might be company address, telephone number, person in charge, contact person, etc. These data often already exist in the database. But during entering the electronic document, they still have to be selected and entered one by one. This type of one by one data entry also cannot meet requirements. But unless designed in the database in advance, users have to know exactly before entering data. They cannot select data input based on rough impression. Hence it is not user-friendly.

### SUMMARY OF THE INVENTION

Therefore the present invention aims to provide a data column management system and method that allow data columns to be added and deleted as desired to meet user's data entry requirements.

The data column management system and method according to the invention can automatically link with the entering data and allow a plurality of sub-data columns to be filled simultaneously by one selection to overcome the disadvantages occurred to the conventional techniques.

The data column management system according to one embodiment of the invention can receive an adding data column request to add data columns to an electronic document, and receive a deleting data column request to delete data columns in the electronic document. The electronic document contains at least one data column, and each data column comprises a plurality of sub-data columns. Each sub-data column may receive data entry. The data column management system comprises a column data accessing module, an adding module, a deleting module and a linking module.

The column data accessing module aims to access the serial number of the last data column of the data columns in the electronic document, and get a last serial number and retrieve the data column format to get a format data. The adding module adds an adding data column to the electronic document according to the adding data column request, the format data and the last serial number. The format of the adding data column conforms to the format data. The serial number of the adding data column is the last serial number plus one. The deleting module deletes any data column of the electronic document according to the deleting data column request. And the data column serial number of the data column after the deleting data column is subtracted by one.

The linking module links to a database which contains a plurality of data. When a user chooses to enter a selected sub-data column of a selected data column, the data column accessing module retrieves the sub-data column serial number of the selected sub-data column and the serial number of the selected data column and gets a mother serial number. The linking module links with the database to enable the user to select a specific entering data, and fills the selected data into the selected sub-data column according to the format based on the sub-data column serial number and the mother serial number, or even fills into other sub-data columns of the data-column.

Therefore, according to the embodiment of the invention, except adding and deleting data columns as desired, data may also be selected and filled into the corresponding sub-data columns. Thus it provides the benefit of adding and deleting data columns that is not available in the conventional techniques, and also overcomes the shortcoming that cannot fill multiple sub-data columns.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional electronic document.

FIG. 2 is a schematic view of an embodiment of the data column management system of the invention.

FIG. 3 is a schematic view of an embodiment of an electronic document of the invention.

FIG. 4 is a schematic view of another embodiment of the electronic document of the invention.

FIG. 5 is a schematic view of an agreement document with an adding data column.

FIG. 6 is a schematic view of an embodiment of a popped up menu according to the invention.

FIG. 7 is schematic view of an agreement document after data have been entered.

FIG. 8 is a flow chart of an embodiment of the data column management method of the invention.

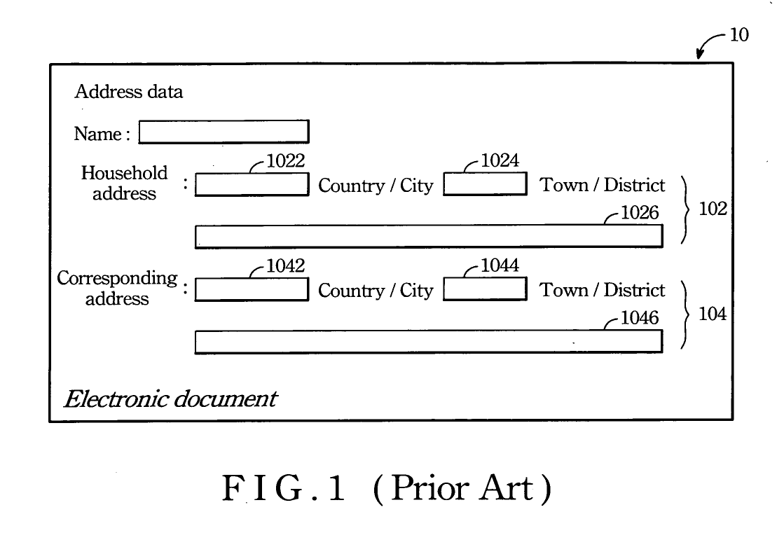

### DESCRIPTION OF THE PREFERRED EMBODIMENTS

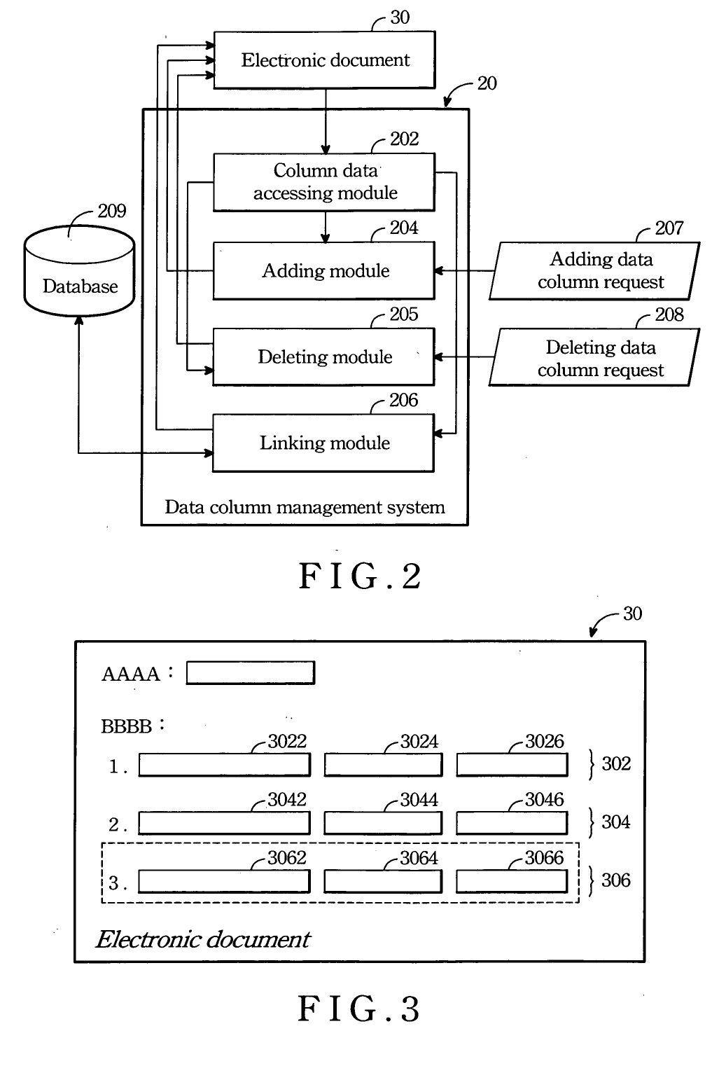

Refer to FIG. 2 for an embodiment of a data column management system 20 and FIG. 3 for an embodiment of an electronic document 30 of the invention. The data column management system 20 aims to add data columns on the electronic document 30. The electronic document 30 comprises at least data column 302 and 304 that contain respectively a plurality of sub-data columns 3022, 3024, 3026, 3042, 3044 and 3046. Each sub-data column is for entering data. The data column management system 20 comprises a column data accessing module 202, an adding module 204, a deleting module 205 and a linking module 206 to receive an adding data column request 207 to add data columns of an electronic document, and to receive a deleting data column request 208 to delete data columns of the electronic document.

The column data accessing module 202 is to access the serial number of the last data column 304 of the data columns 302 and 304, and get a last serial number, and at the same time to access the format of the data column 304 to get a format data. The adding module 204 adds an adding data column 306 to the electronic document 30 according to the format data and the last serial number. The format of the adding data column 306 conforms to the format data, and its serial number is the last serial number plus one.

The linking module 206 links to a database 209 which contains a plurality of entered data. The entered data may directly conform to the format of the data column, or may not directly conform by become indirectly conforming through data format conversion. When a user chooses to enter a selected sub-data column 3046, the column data accessing module 202 accesses a sub-data column serial number of the sub-data column 3046 and the serial number of the data column 306 which the sub-data column 3046 belongs to and gets a mother serial number. The linking module 206 provides a link to the database 209. The database 209 contains multiple entered data that is displayed on an external display device in a table fashion to allow a user to select a specific entering data. After the user has selected the specific entered data, the linking module 206, according to the sub-data column serial number and the mother serial number, fills the selected specific entering data in a one-to-many fashion into all sub-data columns of the data column 306 which the sub-data column 3046 belongs to. Of course, if the data in the database 209 to be entered are in formats or sequence different from the data column 306, the linking module 206 may perform data format conversion and data sequencing processes in advance, and then enter the processed data to be filled into the data column 306.

An embodiment is given below to elaborate the function of the linking module set forth above. When a data column is for entering customer's data of a user, the entered data in the database 209 contain all of customer's data comprising customer name, phone number and address. When a user wants to select and enter a specific sub-data column, such as customer name, the linking module links to the database, and all of customer's data are displayed in a list format before the user (such as through another window on the screen). The user can select a customer name, and the linking module fills all of customer's data comprising name, phone number and address, and the like to the data column in one operation (and converts the data format and rearranges the sequence if necessary). Because the invention can enter multiple sub-data columns at the same time, it is more convenient than the conventional techniques that enter one sub-data column at a time.

The concept of the invention is practical and has no technical difficulty. For instance, data format conversion is a technique well developed, such as converting hexadecimal to octal or quadric-forward. Hence the invention can easily convert the data storing format of the database to the data storing format of the data column (even for each sub-data column). Moreover, rearranging data sequence also may be accomplished easily. For instance, to rearrange the sequence of items 1, 2 and 3 to become items 2, 3 and 1. The invention can rearrange the sequence of each data from the database to the sequence of each sub-data column of the data column. Another conventional technique readily available is to select certain items from a plurality of data, such as selecting A, B and D from A, B, C, D and E. Hence among the data of many different items in the database that are linked corresponding to a selected sub-data column, the data of a few items may be selected to be filled into a corresponding data column.

It is to be noted that the elements of the data column management system in the embodiment of the invention may be integrated into a central processing unit (CPU) of a computer. And all the processing procedures may be programmed and stored in the CPU memory. When the CPU receives the requests for adding or deleting data column, it can execute the programs stored in the memory to implement the present invention. In addition, the data column management system may also be adapted to network architectures, namely, to be implemented on a server and user end computers. The data column management system is resided in the server, while the user end computers generate adding data column requests, deleting data column requests and selecting entering data from the popped up menus. Therefore, the invention may be adapted to the network environments that are widely used at present to fill in various types of electric documents.

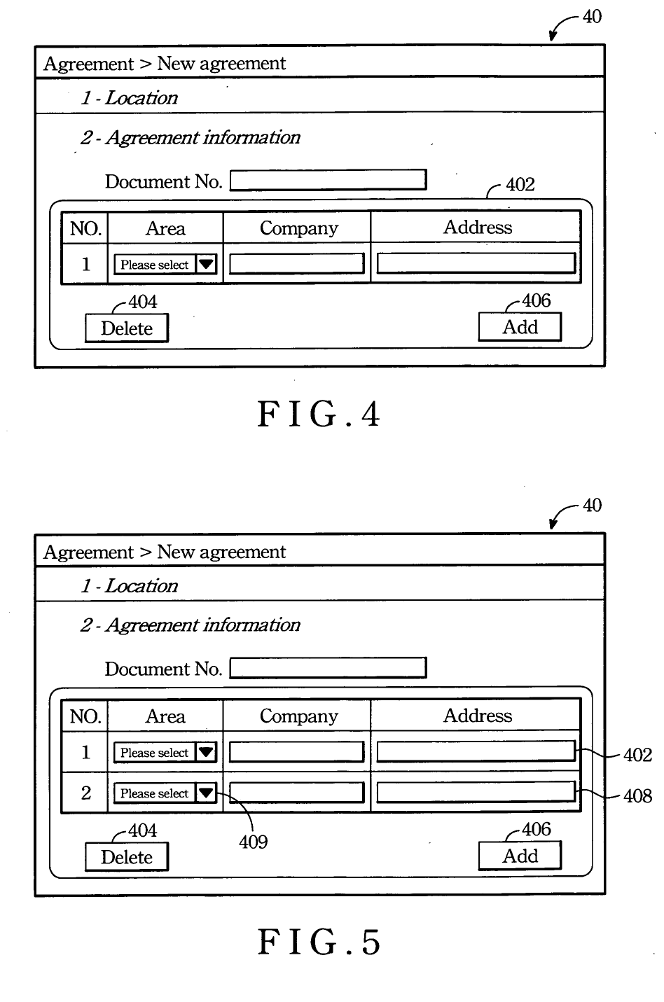

Refer to FIG. 4 for a practical example of the invention in use. The invention may be adopted for use on many types of electronic documents. The example shown in FIG. 4 is an agreement document 40. It comprises a plurality of items (as shown in FIG. 2, the first item is location, the second item is agreement information). Each item contains a plurality of data columns. FIG. 2 is the extension of the second item—agreement information which serves as an example. After the second item is extended, initially a data column 402 is provided for entering data. There is a delete key 404 located on the lower left corner, and an add key 406 located on the lower right corner.

When a user enters data and finds out that the data column 402 is not sufficient, he/she can tick the add key 406, and the column data accessing module 202 will execute programs to get a column serial number (No.) to be added, and in the mean time access a Html program code to be filled in the data column and the format of the original data column. A related program example is as follow:
var RowCount=document.all.ItemName.rows.length;
Cell_{—}0=“<font color=W″000066W″><strong>”+RowCount+“</strong></font>”.

The adding module 204 adds an adding data column 408 according to the data set forth above. An example of program codes is as follow:
New Row=document.all.ItemName.insertRow (document.all.ItemName.rows.length);

The Html program codes and column format may also be set through the following program codes which serve as an example:
//New “Cell_{—}0” Column
NewRow.insertCell( );
NewRow.cells[0].innerHTML=Cell_{—}0;
NewRow.cells[0].width=‘18’;
NewRow.cells[0].align=‘center’;

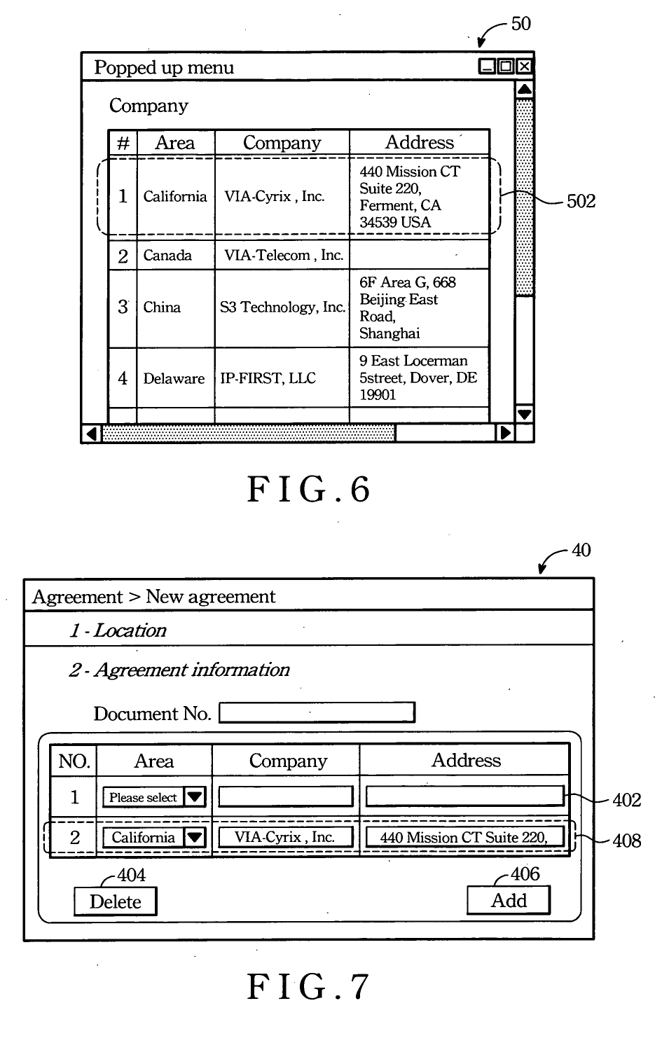

In short, a whole row of data columns may be added or deleted on the agreement document 40 according to requirements. Similarly, deleting a data column may also be accomplished by slightly altering the program codes. Refer to FIG. 5 for adding a data column 408 on the agreement document 40 in FIG. 4, and FIG. 6 for a popped up menu 50. FIG. 5 shows the agreement document 40 after the adding data column has been added. Two rows of data columns 402 and 408 appear to allow the user to enter data. The user can enter data in the adding data columns by ticking a pull down key 409 in FIG. 5. As shown in FIG. 6, a pull down menu 50 will appear for user selection. This process is accomplished by linking the linking module 206 and the database 209. While the pull down key 409 is ticked, the data accessing module 202 transfers the selected column serial number (No.). An example of execution program codes is as follow:

<select name=“VIASerialNo_1” class=“font12” style=“width:140px”
onFocus=“showVIACompany(document.form1, ‘1’);”>
<option value=“−1” selected>-Select-</option>
</select>
<script language=“JavaScript”>
function showVIACompany(objForm, textNo)
{objForm.purpose.focus( );
var actionURL = “ShowVIACompany.jsp?textNo=“+ textNo;
openFormWin(actionURL);}
</script>

Meanwhile, the linking module 206 arranges all of data in the database 209 related to the selected one to become the pull down menu 50 according to the selected contents to allow users to select. An example of execution program codes is as follow:

<%
String textNo = request.getParameter(“textNo”);
%>

Then the linking module 206 gets the selected data from the database 209. An example of execution program codes is as follow:

<SCRIPT language=JavaScript>
<!--
function setText(serialNo)
{
var openerForm = window.opener.document.form1;
<%

Then through the while loop in the program codes of the linking module 206, the program codes for selecting each data item may be assembled as follow:

while (cPartyCompanySql.next( )){
%>
if (serialNo == “<%=cPartyCompanySql.getSerialNo( )%>”)
{openerForm.PartyCompany_<%=textNo%>.value = “<%=
cPartyCompanySql.getPartyCompany( ))) %>”; }
<%
} // End while
%>
window.close( );
}
//-->
</SCRIPT>

Refer to FIG. 7 for the agreement document 40 shown in FIG. 4 after the data have been entered. When the user has ticked a first selected data 502, the linking module 206 will fill the selected data in an one-to-many fashion into the data column 408, and close the popped up menu 50. Meanwhile, the agreement document 40, as shown in FIG. 7, contains the data selected by the user. Thus the invention, besides to add and delete data columns as desired, also can fill the data from the popped up menu into the electronic document in an one-to-many fashion.

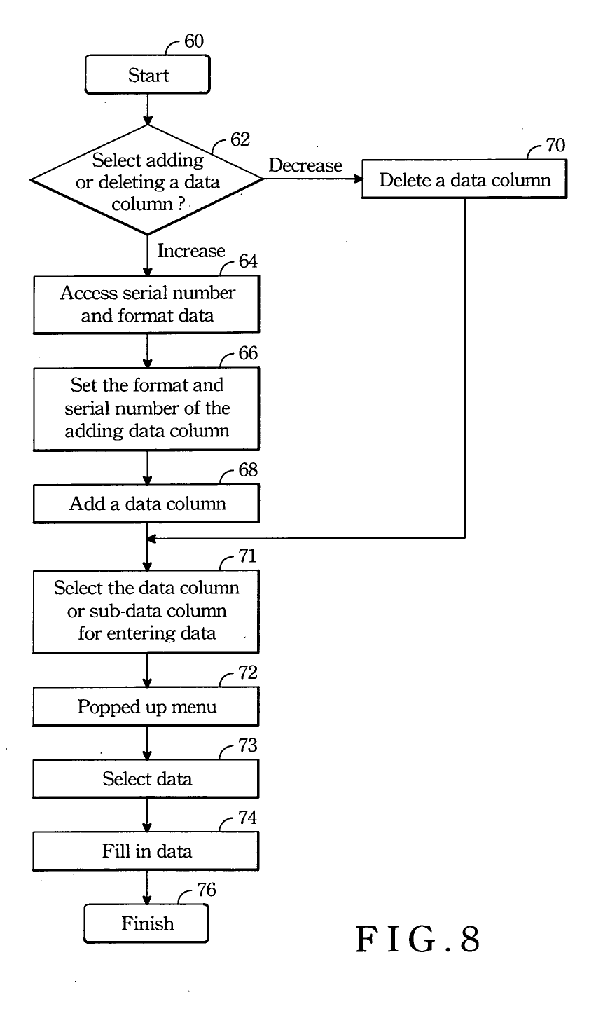

Refer to FIG. 8 for the process flow of an embodiment of the method of the data column management system according to the invention. It comprises the following steps:
Step 60: Start, select an electronic document 30;
Step 62: Select adding or deleting a data column; proceed Step 64 for adding; proceed Step 70 for deleting;
Step 64: Access the serial number and format data of the data column on the last row;
Step 66: Design the format of the adding data column based on the format code, and set the serial number of the adding data column based on the serial number plus one;
Step 68: Add an adding data column on the electronic document 30;
Step 70: Delete a designated data column, and subtract one from the data column serial number of the designated data column;
Step 71: Choose a selected data column, and choose a selected sub-data column from the selected data column;
Step 72: Display a popped up menu, access the serial number and format of the data column belonged to the pull down key;
Step 73: Select the data to be entered from the popped up menu;
Step 74: Fill the data to be entered into the data column of the pull down key according to the serial number of the pull down key;
Step 76: Finish

It is to be noted that, Step 62 to Step 70 relate to adding and deleting of data column, and Step 71 to Step 74 relate only to data selection and entering. Hence for an application merely for adding and deleting data column without entering data contents, Step 62 to Step 70 are sufficient (especially for deleting at least one data column). On the other hand, for an application aiming only at altering data to be filled in the data column, Step 60 and Step 71 to Step 74 will be sufficient.

In summary, the invention overcomes the disadvantages occurred to the conventional techniques. It allows users to add and delete data columns as desired, and also enter data in an one-to-many fashion from a popped up menu into the data columns to save user's time.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A data column management system for receiving an adding/deleting data column request to add/delete data columns on an electronic document which has at least one data column, comprising:
a column data accessing module for accessing a last data column of the data columns of the electronic document to get a last serial number and accessing a format of the last data column to get a format data;
an adding module for adding an adding data column to the electronic document according to the adding data column request, the format data and the last serial number, the adding data column having a format conforming to the format data and a serial number being the last serial number plus one; and
a deleting module for deleting a data column according to the deleting data column request and subtracting the serial number of a data column after the deleted data column by one.

2. The data column management system of claim 1, wherein the data column comprises a plurality of sub-data columns, each of the sub-data column being allowed to receive entering data.

3. A data column management system for processing data input of an electronic document which has at least one data column which in turn has at least one sub-data column, comprising:
a column data accessing module for accessing a sub-data column serial number of a selected sub-data column and a data column serial number of a selected data column which the selected sub-data column belongs to get a mother serial number when the selected sub-data column of the electronic document is chosen; and
a linking module for linking with a database which contains a plurality of entering data when the selected sub-data column of the electronic document is chosen to get a selected entering data, and filling the selected entering data into the selected sub-data column according to the sub-data column serial number and the mother serial number.

4. The data column management system of claim 3, wherein the linking module converts the format of the selected entering data to a corresponding format of the sub-data column before filling the selected sub-data column.

5. The data column management system of claim 3, wherein the linking module accesses at least one corresponding additional entering data during accessing the entering data and fills both the entering data and the additional entering data into the selected data column.

6. The data column management system of claim 5, wherein the linking module converts the format of the additional entering data to the format of the corresponding selected data column before filling into the selected data column

7. The data column management system of claim 5, wherein the linking module rearranges the sequence of the entering data and the additional entering data according to the sequence of corresponding items of each sub-data column of the corresponding data column before filling into the selected data column.

8. The data column management system of claim 5, wherein the linking module selects data of a plurality of items from data of multiple items in the database linked to the corresponding sub-data column before filling into the data column corresponding to the sub-data column.

9. A data column management method for receiving an adding data column request to add data columns on an electronic document which has at least one data column and a deleting data column request to delete data columns from the electronic document, comprising the steps of:
accessing a serial number of a last data column from the data columns of the electronic document to get a last serial number and accessing a format of the last data column to get a format data;
adding an adding data column to the electronic document according to the adding data column request, the format data and the last serial number, the adding data column having a format conforming to the format data and a serial number being the last serial number plus one; and
deleting a data column from the data columns according to the deleting data column request and subtracting the serial number the data column after the deleting data column by one.

10. The method of claim.9, wherein the data column contains a plurality of sub-data columns, each of the sub-data columns being allowed to receive entering data.

11. A data column management method for processing data input of an electronic document which comprises at least one data column which in turn contains at least one sub-data column, comprising the steps of:
choosing a selected sub-data column on the electronic document;
accessing a sub-data column serial number of the sub-data column and a serial number of a data column which the sub-data column belongs to get a mother serial number;
linking a database which contains a plurality of entering data to get a selected entering data; and
filling the selected entering data into the selected sub-data column according to the sub-data column serial number and the mother serial number.

12. The method of claim 11 further comprising converting the format of the selected entering data corresponding to the format of the sub-data column before filling the selected sub-data column.

13. The method of claim 11 further comprising accessing at least one corresponding additional entering data during accessing the entering data and filling the entering data and the additional entering data into the selected data column.

14. The method of claim 13 further comprising converting the format of the additional entering data to the format of a corresponding selected data column before filling into the selected data column.

15. The method of claim 13 further comprising rearranging the sequence of the entering data and the additional entering data according to the sequence of corresponding items of each sub-data column of the corresponding data column before filling into the selected data column.

16. The method of claim 13 further comprising selecting data of a plurality of items from data of multiple items in the database linked to the corresponding sub-data column before filling into the data column corresponding to the sub-data column.
